(19) United States
(12) Patent Application Publication
(10) Pub. No.: US 2011/0035575 A1
(43) Pub. Date: Feb. 10, 2011

(54) MULTIPROCESSOR SYSTEM COMPRISING MULTI-PORT SEMICONDUCTOR MEMORY DEVICE

(75) Inventor: Jin-Hyoung KWON, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/780,989

(22) Filed: May 17, 2010

(30) Foreign Application Priority Data
Aug. 4, 2009 (KR) 10-2009-0071548

(51) Int. Cl. G06F 12/02; G06F 9/24; G06F 15/76; G06F 9/02

(52) U.S. Cl. 713/2; 711/103; 712/36; 711/105; 711/149; 711/102; 711/E12.007; 711/E12.008; 712/E09.002

(57) ABSTRACT

A multiprocessor system comprises first and second processors connected to a multi-port semiconductor memory device. The multi-port semiconductor memory device comprises a shared memory area and a plurality of mailbox areas used for inter-processor communication. The first and second processors use a single nonvolatile memory device for storing boot data and transmit information for booting via the shared memory area.

### CROSS-REFERENCE TO RELATED APPLICATIONS

This application claims priority under 35 U.S.C. § 119 to Korean Patent Application 10-2009-0071548 filed on Aug. 4, 2009, the disclosure of which is hereby incorporated by reference in its entirety.

### BACKGROUND

Embodiments of the inventive concept relate generally to multiprocessor systems. More particularly, embodiments of the inventive concept relate to multiprocessor systems using a multi-port semiconductor memory device as a shared memory.

A number of modern consumer electronic systems incorporate multiple processors in an effort to enhance performance. Examples of such systems include portable media players, smart phones, global positioning systems, digital cameras, digital video cameras, and a personal digital assistants, to name but a few.

In many of these systems, the multiple processors are used to perform different functions. For instance, in modern smart phones, one processor can be used to process baseband communications, another processor can be used to process multimedia data, another processor can be used to run operating system code, and so on.

In most multiprocessor systems, each processor is connected to a separate memory, such as a dynamic random access memory (DRAM) or a static random access memory (SRAM). Each of these memories typically has enough access ports to allow data exchange between the corresponding processor and external devices such as a host. These ports, however, are generally used for communication with only one processor.

Some newer multi-port semiconductor memory devices now allow simultaneous communication with multiple processors. For instance, OneDRAM™, made by Samsung, is a fusion memory chip capable of increasing a data processing speed between two processors such as a communication processor and a media processor in a mobile device. OneDRAM™ routes data between the processors through a single chip and substantially reduces the amount of time taken to transmit data between processors using a dual-port approach.

To simplify multiprocessor systems that have a multi-port semiconductor memory device, and to reduce the cost of such multiprocessor systems, boot loaders for multiple processors can be stored in a non-volatile semiconductor memory device such as a flash memory, connected to only one of the processors. In other words, multiprocessor systems can be implemented with a “flash-less” configuration in which at least one processor is not directly connected to any flash memory.

In a system having a flash-less configuration, a serial interface such as a universal asynchronous receiver transmitter (UART) or serial peripheral interface (SPI) is generally used to transfer information such as boot loaders between processors. Unfortunately, however, the transmission of boot data through a serial interface tends to be relatively slow, resulting in degradation in booting performance and complications in system design.

In addition, a multiprocessor system comprising a multi-port semiconductor memory device can further incorporate a memory link architecture in which a separate processor is linked to another multi-port semiconductor memory device and a flash memory. In this configuration, the addition of further flash memories tends to increase the cost and size of the system.

### SUMMARY

Certain embodiments of the inventive concept provide multiprocessor systems comprising a multi-port semiconductor memory device and having improved booting performance. Certain embodiments provide multiprocessor systems capable of being booted up without a serial interface. Certain embodiments provide multiprocessor systems capable of flash-less booting in a two-processor configuration having a multi-port semiconductor memory device and a memory link architecture. Certain embodiments provide multiprocessor systems capable of being booted using a memory in a memory link architecture without memories provided for individual processors. Certain embodiments provide multiprocessor systems comprising a multi-port semiconductor memory device and having reduced cost.

According to one embodiment, a multiprocessor system comprises a multi-port semiconductor memory device comprising a shared memory area and a plurality of mailbox areas used for inter-processor communication, a first processor connected to the multi-port semiconductor memory device and comprising an internal read only memory (ROM) storing default initialization codes for initializing a DRAM controller in a booting operation of the first processor, a second processor connected to the multi-port semiconductor memory device and performing communication with the first processor through the multi-port semiconductor memory device, and a non-volatile semiconductor memory device connected to the second processor and storing user data, software, and boot loaders for the first and second processors.

In certain embodiments, the ROM in the first processor stores a primary boot loader for the first processor, the second processor comprises a ROM storing a primary boot loader for the second processor, and the first processor initializes the DRAM controller with default parameters in accordance with the default initialization codes.

In certain embodiments, the multi-port semiconductor memory device comprises a first memory area dedicated to the first processor and a second memory area dedicated to the second processor, and the second processor performs a first transfer operation after executing the primary boot loader, the first transfer operation comprising reading second processor operating system image data from the non-volatile semiconductor memory device and storing the second processor operating system image data in the second memory area.

In certain embodiments, the second processor further performs a second transfer operation after the first transfer operation, the second transfer operation comprising reading a secondary boot loader and first processor operating system image data from the non-volatile semiconductor memory device and storing the secondary boot loader and the first processor operating system image data in the shared memory area.

In certain embodiments, the first processor performs a reset/copy operation after the second transfer operation, the reset/copy operation comprising reading the secondary boot loader from the shared memory area to reset the DRAM controller, reading the first processor operating system image data from the shared memory area, and copying of the first processor operating system image data in the first memory area.

In certain embodiments, the second processor applies a reset signal to the first processor to prevent the first processor from halting during booting of the multiprocessor system.

In certain embodiments, the nonvolatile memory device is a flash memory device.

According to another embodiment, a multiprocessor system comprises a first multi-port semiconductor memory device and first and second processors connected to the first multi-port semiconductor device, where the first and second processors have common access to the first multi-port semiconductor device. The system further comprises a memory link architecture block comprising a second multi-port semiconductor memory device connected to the second processor, a non-volatile semiconductor memory device, and a third processor connected to the second multi-port semiconductor memory device and the non-volatile semiconductor memory device, the third processor controlling booting of the first and second processors by transferring boot data from the non-volatile semiconductor memory device to the first and second processors.

In certain embodiments, the second processor and the third processor are connected to each other through a serial interface line and a reset signal line.

In certain embodiments, the third processor applies reset signals to the first and second processors to prevent the first and second processors from halting during booting of the multiprocessor system.

In certain embodiments, the third processor controls booting of the second processor by releasing the second processor from a reset state, reading a boot loader and operating system image data for the second processor from the non-volatile semiconductor memory device, transmitting the boot loader through the serial interface line, and storing the operating system image data in a shared memory area of the second multi-port semiconductor memory device.

In certain embodiments, the third processor controls booting of the first processor by releasing the first processor from a reset state following booting of the second processor, reading a boot loader and operating system image data for the first processor from the non-volatile semiconductor memory device, transmitting the boot loader through the serial interface line, and storing the operating system image data in a shared memory area of the second multi-port semiconductor memory device.

In certain embodiments, the first and second processors receive data from the third processors via first and second respective UART circuits.

In certain embodiments, the third processor is an application specific integrated circuit (ASIC).

In certain embodiments, one of the first and second processors is a multimedia processor.

According to still another embodiment, a method of operating a multiprocessor system comprises (a) operating a first processor to execute a primary boot loader stored in a ROM coupled to the first processor, (b) operating a second processor to execute a primary boot loader stored in a ROM coupled to the second processor, (c) operating the second processor to read a second boot loader of the second processor from a nonvolatile memory, and to execute the second boot loader of the second processor to read operating system (OS) image data for the second processor from the nonvolatile memory, (d) operating the second processor to read a second boot loader of the first processor and OS image data for the first processor from the nonvolatile memory, and to store the second boot loader of the first processor and the OS image data for the first processor in a shared memory area in a multi-port semiconductor memory device, and (e) operating the first processor to read the secondary boot loader of the first processor and the OS image data for the first processor from the shared memory area, and to execute the second boot loader of the first processor.

In certain embodiments the method further comprises initializing a DRAM controller of the first processor using default initialization parameters stored in the ROM coupled to the first processor, and subsequently resetting the DRAM controller with parameters defined by the second boot loader of the first processor.

In certain embodiments, the multi-port semiconductor memory device comprises a OneDRAM device.

In certain embodiments, the nonvolatile memory device comprises a flash memory device.

In certain embodiments, the second boot loader of the first processor is transferred to the first processor by storing the second boot loader of the first processor in the shared memory and changing a state of a semaphore to provide the first processor with access to the second boot loader of the first processor.

### BRIEF DESCRIPTION OF THE DRAWINGS

Embodiments of the inventive concept are described below with reference to the accompanying drawings. In the drawings, like reference numbers denote like features.

FIG. 1 is a block diagram illustrating a multiprocessor system according to an embodiment of the inventive concept.

FIG. 2 is a flowchart illustrating a booting sequence for processors shown in FIG. 1.

FIG. 3 is a block diagram illustrating a multiprocessor system according to another embodiment of the inventive concept.

FIG. 4 is a block diagram illustrating a multiprocessor system according to a still another embodiment of the inventive concept.

FIG. 5 is a block diagram illustrating a first multi-port semiconductor memory device shown in FIG. 4.

FIG. 6 is a block diagram illustrating a second multi-port semiconductor memory device shown in FIG. 4.

FIG. 7 is a diagram illustrating internal storage areas of a non-volatile semiconductor memory device shown in FIG. 4.

### DETAILED DESCRIPTION OF THE EMBODIMENTS

Selected embodiments will now be described more fully with reference to the accompanying drawings. In the description of the embodiments, specific structural and functional details are provided for teaching purposes. The inventive concept, however, should not be construed to be limited to the provided details, examples, or embodiments.

Although certain terms of distinction, such as first, second and third, are used herein to describe various elements, these elements should not be limited by these terms. Rather, these terms are only used to differentiate between elements. For example, a first element could be termed a second element, and, similarly, a second element could be termed a first element, without departing from the scope of the described embodiments. As used herein, the term “and/or” includes any and all combinations of one or more of the associated listed items.

It will be understood that where an element is referred to as being “connected” or “coupled” to another element, it can be directly connected or coupled to the other element or intervening elements may be present. In contrast, where an element is referred to as being “directly connected” or “directly coupled” to another element, there are no intervening elements present. Other words used to describe the relationship between elements should be interpreted in a similar fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises”, “comprising”, “includes”, and/or “including”, where used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

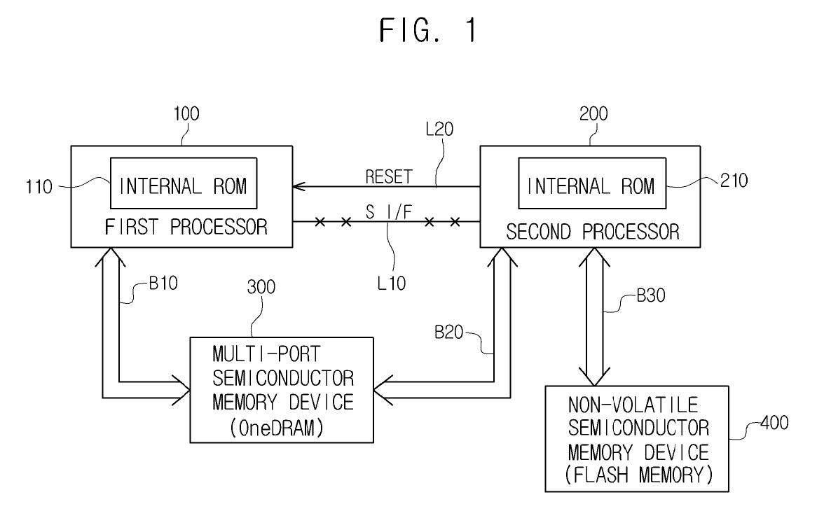

FIG. 1 is a block diagram illustrating a multiprocessor system according to an embodiment of the inventive concept.

Referring to FIG. 1, the multiprocessor system comprises a first processor 100, a second processor 200, a multi-port semiconductor memory device 300 such as a OneDRAM™, and a non-volatile semiconductor memory device 400 such as a flash memory (hereinafter, flash memory 400).

In this embodiment, first processor 100 functions as a modulation demodulation (MODEM) processor, and second processor 200 functions as an application processor for running user applications. In alternative embodiments, first and second processors 100 and 200 may perform different functions or additional functions.

First processor 100 is connected to multi-port semiconductor memory device 300 through a system bus B10 and second processor 200 is connected to multi-port semiconductor memory device 300 through a system bus B20 such that first and second processors 100 and 200 both have access to multi-port semiconductor memory device 300. By providing both processors with access to multi-port semiconductor device 300, the cost and size of the multiprocessor system can be reduced in comparison with multiprocessor systems using a different memory device for each processor.

Flash memory 400 is connected to second processor 200 through a system bus B30. Accordingly, first processor 100 can access flash memory 400 indirectly through multi-port semiconductor memory device 300 and second processor 200. Second processor 200 can access flash memory 400 directly.

Flash memory 400 typically comprises a NOR-type flash memory or a NAND-type flash memory. Flash memory 400 is used to store data requiring nonvolatile storage, such as communication data, programs, or boot codes of a mobile device. Since the multiprocessor system comprises one flash memory 400 for two processors, the cost and size of the system may be relatively low compared with other multiprocessor systems.

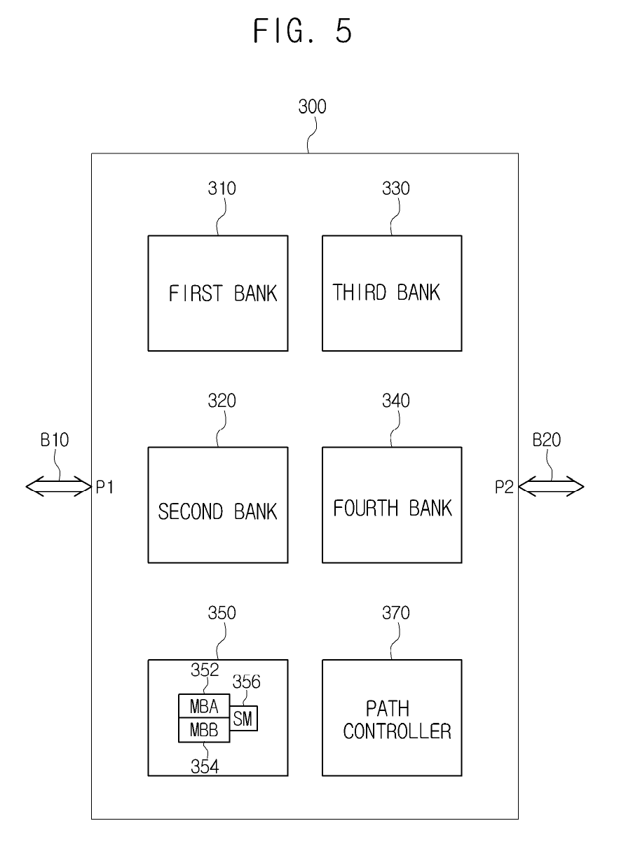

Multi-port semiconductor memory device 300 functions as a main memory for first and second processors 100 and 200. In an embodiment shown in FIG. 5, multi-port semiconductor memory device 300 has multiple ports P1 and P2 and a plurality of memory banks 310, 320, 330, and 340.

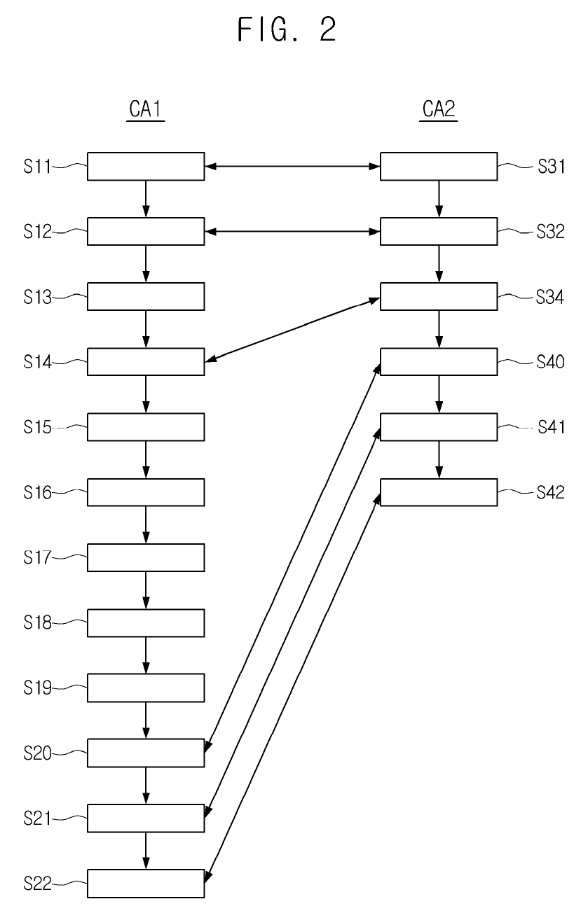

In the configuration of FIG. 1, a serial interface L10, such as a UART or SPI interface, is provided between the processors. Serial interface L10 functions to transmit booting data between first and second processors 100 and 200. Such a multiprocessor system can be booted up according to a booting sequence CA1 shown in FIG. 2.

FIG. 2 is a flowchart illustrating example booting sequences CA1 and CA2 for first and second processors 100 and 200 shown in FIG. 1. In the description that follows, example steps in the booting sequences are denoted by parentheses (SXX).

In booting sequence CA1, upon powering up of the multiprocessor system, first and second processors 100 and 200 each read a primary boot loader from its own internal ROM and execute the primary boot loader (S11). Thereafter, second processor 200 reads a secondary boot loader from flash memory 400 and executes the secondary boot loader (S 12). Then, second processor 200 applies a reset signal to first processor 100 through a signal line L20 to place first processor 100 in a reset state, which prevents first processor 100 from halting (S 13). Second processor 200 then reads operating system (OS) image data from flash memory 400 and stores the OS image data in a dedicated memory area of multi-port semiconductor memory device 300 to complete the booting of second processor 200 (S 14).

Second processor 200 next reads a secondary boot loader for first processor 100 from flash memory 400 and prepares to transmit the secondary boot loader (S15). Second processor 200 then releases first processor 100 from the reset state (S16), and first processor 100 is prepared to receive the secondary boot loader through serial interface line L10 (S17). For instance, in step S17, UART protocol matching, baud rate matching, and cyclic redundancy check (CRC) error-detecting code matching may be performed between first and second processors 100 and 200.

Thereafter, second processor 200 transmits the secondary boot loader to first processor 100 through serial interface line L10 (S18). Then, first processor 100 executes the secondary boot loader to initialize its own DRAM controller (S19). Subsequently, second processor 200 reads OS image data for first processor 100 from flash memory 400 and stores the OS image data in a shared memory area of multi-port semiconductor memory device 300 (S20). Then, first processor 100 reads the OS image data from the shared memory area and makes a copy of the OS image data to a dedicated memory area (S21). Thereafter, the booting of first processor 100 is completed (S22). Accordingly, after step S22, booting of both first processor 100 and second processor 200 are completed.

The primary boot loaders described above are programs that perform low-level initialization on corresponding processors and may be a master boot recorder (MBR). The primary boot loaders are typically written in assembly language. Immediately after system power is turned on, first processor 100 and second processor 200 each read and execute a primary boot loader to perform various initialization operations such as setting registers in corresponding memory controllers, setting rates of system clocks, and initializing UARTs. The secondary boot loaders are programs that load the operating systems of corresponding processors. Each secondary boot loader typically comprises an NT loader (NTLDR) or grand unified boot-loader (GRUB). In some embodiments, the secondary boot loader for high-level initialization is written in a programming language such as C.

The speed of booting sequence CA1 may be somewhat slow due to limits on the speed of serial interface line L10 and consequent slow transmission of boot data. The slow transmission of boot data may cause degradation in booting performance and difficulty in transmission protocol matching, leading to inefficient system performance.

Booting sequence CA2 can overcome some of these shortcomings of booting sequence CA1. In booting sequence CA2, default setting codes are stored in an internal ROM of processors 100 and 200 to initialize DRAM controllers with default parameters, eliminating the need to transfer some data through a relatively slow serial interface. In this way, it is possible to simplify a flash-less booting sequence and a board design and to increase the booting speed without UART protocol matching, such as baud rate matching and CRC error-detecting code matching, between processors.

The booting sequence CA2 will now be described in further detail with reference to FIG. 2. Referring to FIG. 2A, upon power up of the multiprocessor system, first and second processors 100 and 200 read and execute primary boot loaders stored in respective internal ROMs 110 and 210 (S31). For instance, first processor 100 initializes a DRAM controller with default parameters using default setting codes stored in internal ROM 110.

Second processor 200 reads a secondary boot loader for itself from flash memory 400 and executes the secondary boot loader (S32). Second processor 200 then reads OS image data from flash memory 400 and stores the OS image data in a dedicated memory area of multi-port semiconductor memory device 300 (S34) to complete booting of second processor 200.

Second processor 200 subsequently reads a secondary boot loader and OS image data for first processor 100 from flash memory 400 and stores the secondary boot loader and OS image data in a shared memory area of multi-port semiconductor memory device 300 (S40).

First processor 100 reads the secondary boot loader from the shared memory area and resets the DRAM controller with parameters provided by the secondary boot loader (S41). First processor 100 also reads the OS image data from the shared memory area and makes a copy of the OS image data in a dedicated memory area corresponding to the first processor. Following step 541, the booting of first processor 100 is completed (S42). Accordingly, after step 542, booting of both first processor 100 and second processor 200 are completed.

In FIG. 2, lateral arrows are drawn between different steps of booting sequences CA1 and CA2 to indicate steps that are present in booting sequence CA1 but absent in booting sequence CA2. As indicated in FIG. 2, booting sequence CA2 is performed without using any serial interfaces, and booting sequence CA2 omits steps S13, S15, S16, S17, S18, and S19 from booting sequence CA1.

As indicated by the above description, where the multiprocessor system of FIG. 1 uses booting sequence CA2 without using any serial interfaces, booting speed and system design can be improved.

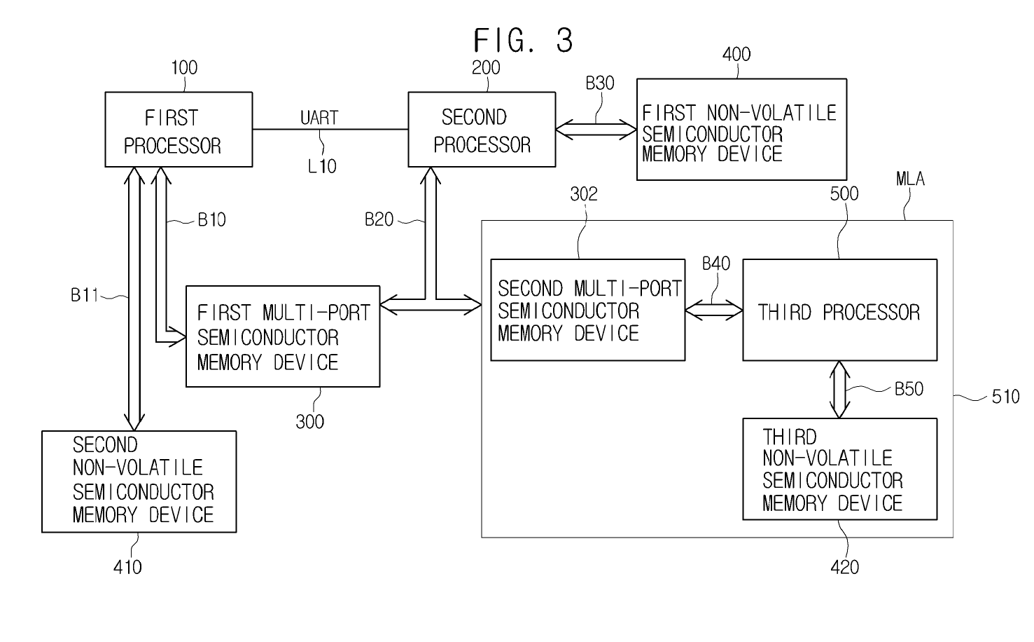

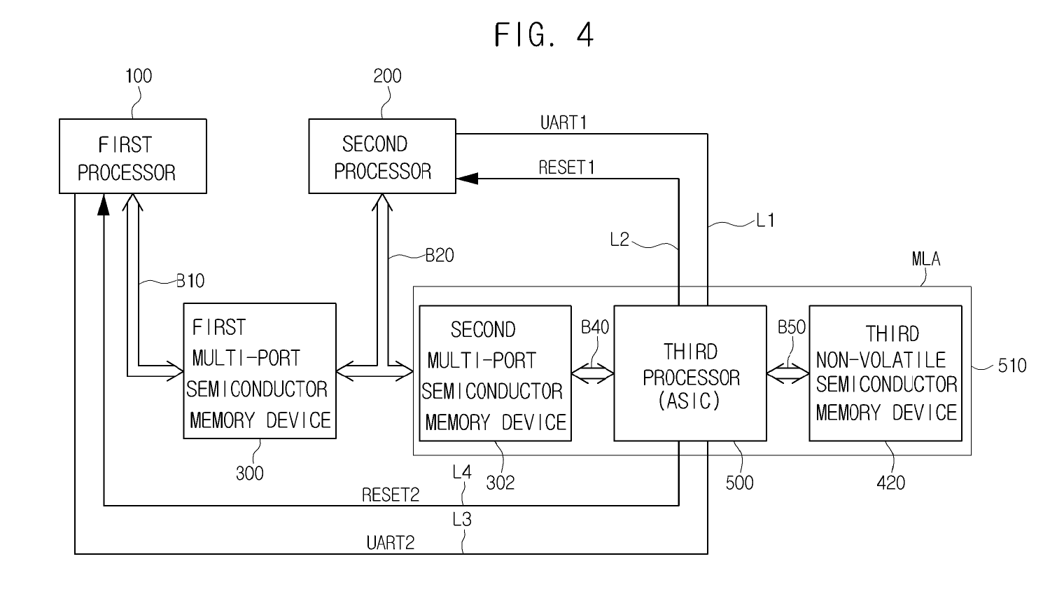

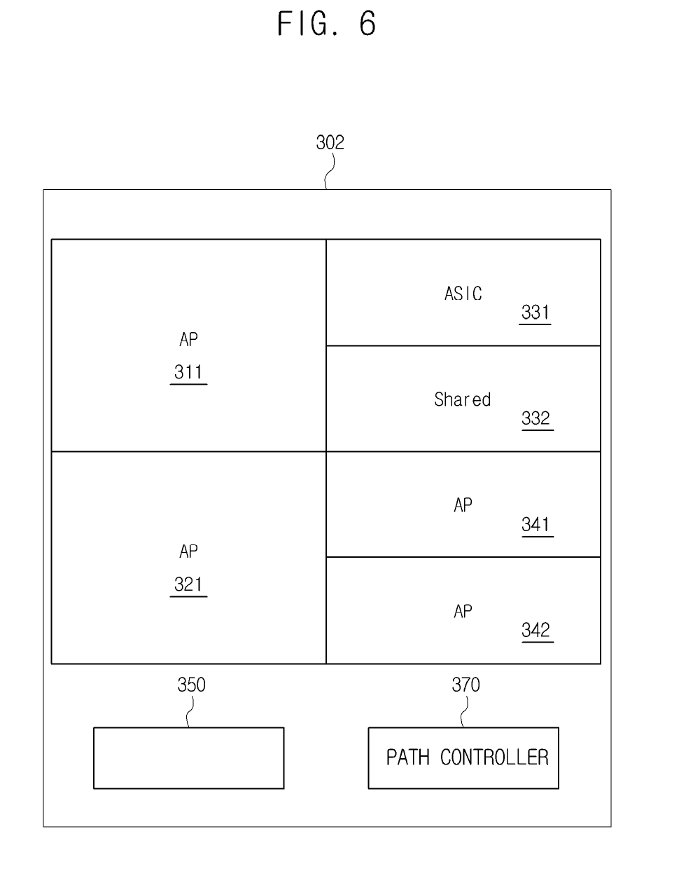

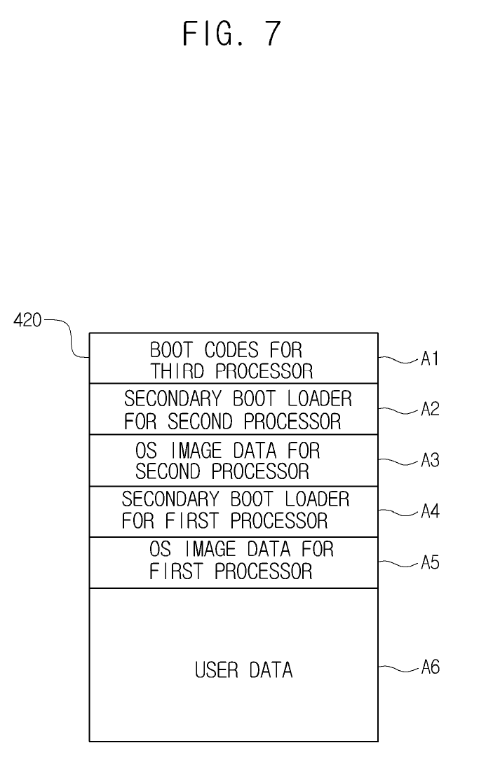

FIGS. 3 through 7 illustrate additional embodiments of multiprocessor systems and related components. In particular, FIGS. 3 and 4 illustrate different embodiments of a multiprocessor system, FIG. 5 illustrates a first multi-port semiconductor memory device shown in FIG. 4, FIG. 6 illustrates a second multi-port semiconductor memory device shown in FIG. 4, and FIG. 7 illustrates internal storage areas of a non-volatile semiconductor memory device shown in FIG. 4.

The multiprocessor system shown in FIG. 3 is similar to that of FIG. 1, except that the multiprocessor system of FIG. 3 further comprises a flash memory 410 connected to first processor 100 and to a memory link architecture block 510 connected to second processor 200 via system bus B20. Memory link architecture block 510 comprises a multi-port semiconductor memory device 302 such as OneDRAM, a third processor 500 comprising an application specific integrated circuit (ASIC) processor, and a flash memory 420. In some embodiments, third processor 500 functions as a media processor.

In the configuration of FIG. 3, first, second, and third processors 100, 200, and 500 read and execute corresponding secondary boot loaders from flash memories 400, 410, and 420, respectively. As shown in FIG. 3, separate flash memories can be provided to each processor in a two-processor system for booting operations. However, the use of a separate flash memory for each processor tends to increase system size and cost.

FIG. 4 illustrates an embodiment of a multiprocessor system having a flash-less configuration. This configuration is similar to that of FIG. 3, except that it omits nonvolatile memory devices 400 and 410.

Referring to FIG. 4, the multiprocessor system comprises first and second processors 100 and 200, multi-port semiconductor memory device 300, and memory link architecture 510, but no flash memory is assigned specifically to either first or second processors 100 or 200. In this configuration, first and second processors 100 and 200 are booted up using a flash memory in the memory link architecture. In this embodiment, first and second processors 100 and 200 typically support a UART booting function.

Referring to FIG. 4, second processor 200 and third processor 500 are connected to each other by a serial interface line L1 and a reset signal line L2, and first processor 100 and third processor 500 are connected to each other by a serial interface line L3 and a reset signal line L4. These lines are used to boot up the multiprocessor system.

In FIG. 4, the memory link architecture block 510 comprises a second multi-port semiconductor memory device 302 such as OneDRAM, a flash memory 420, and third processor 500. Second multi-port semiconductor memory device 302 is connected to second processor 200 via system bus B20. Third processor 500 is connected to second multi-port semiconductor memory device 302 and flash memory 420, and applies reset signals to first and second processors 100 and 200 through reset signal lines L2 and L4 to prevent first and second processors 100 and 200 from halting during booting of the system.

FIG. 5 is a block diagram illustrating an embodiment of first multi-port semiconductor memory device 300 shown in FIG. 4. In the embodiment of FIG. 5, a first port P1 of first multi-port semiconductor memory device 300 is connected to first processor 100 by system bus B10, and a second port P2 thereof is connected to second processor 200 by system bus B20. First and second processors 100 and 200 access memory banks of first multi-port semiconductor memory device 300 through two different access paths.

In this embodiment, first multi-port semiconductor memory device 300 comprises a memory cell array comprising first through fourth memory banks 310 through 340. First bank 310 is dedicated to first processor 100 and third and fourth banks 330 and 340 are dedicated to second processor 200. Second bank 320 is accessed by both of first and second processors 100 and 200 through different ports. Consequently, second bank 320 constitutes a shared memory area of first multi-port semiconductor memory device 300, and first, third and fourth banks 310, 330 and 340 constitute dedicated memory areas accessed only by a corresponding one of first and second processors 100 and 200.

Where first processor 100 accesses second bank 320 through first port P1, a path controller 370 of first multi-port semiconductor memory device 300 controls second bank 320 to be coupled to system bus B10. While first processor 100 accesses second bank 320, second processor 200 can access third bank 330 or fourth bank 340. Where first processor 100 does not access second bank 320, second processor 200 can access second bank 320 serving as the shared memory area.

First, second, third, and fourth memory banks 310, 320, 330, and 340 typically comprise DRAM cells arranged in one or more memory areas. Each memory bank typically has a storage capacity of, for example, 16 Mb (Megabits), 32 Mb, 64 Mb, 128 Mb, 256 Mb, 512 Mb or 1024 Mb.

An internal register 350 provides a separate data storage area to store path control information for path controller 370 and to provide an interface between first and second processors 100 and 200. Internal register 350 can be accessed by first and second processors 100 and 200 and typically comprises a latch circuit such as a flip-flop circuit. Internal register 350 comprises latch-type memory cells, such as SRAM cells, which do not require a refresh operation as DRAM memory cells do.

Internal register 350 comprises a semaphore area 356, a first mailbox area 352, and a second mailbox area 354. Semaphore area 356 stores an indication of access authority for the shared memory area. In the first and second mailbox areas 352 and 354, messages are written according to a predetermined transmission direction. The message typically comprises authority requests, addresses, the size of data, transmission data indicating an address of a shared memory in which data is stored, and/or commands given to counterpart processors.

Messages transmitted from first processor 100 to second processor 200 are stored in first mailbox area 352, and messages transmitted from second processor 200 to first processor 100 are stored in second mailbox area 354. Semaphore area 356 typically stores one or more bits and first and second mailbox areas 352 and 354 typically store 16 bits each.

Where a data interface between first and second processors 100 and 200 is obtained through first multi-port semiconductor memory device 300, first and second processors 100 and 200 can write messages to counterpart processors of receiving entities using first and second mailbox areas 352 and 354. A counterpart processor of a receiving entity reads a written message, recognizes the message of the transmitting processor and performs a corresponding operation.

As an example, where second processor 200 of FIG. 4 transfers access authority for second bank 320 of multi-port semiconductor memory device 300 to first processor 100, second processor 200 changes a flag of semaphore area 356 in internal register 350, and then writes a message to indicate that the access authority has been transferred to first processor 100, to second mailbox area 354. First processor 100 reads the message for the transfer of access authority from second mailbox area 354 and confirms whether the flag data of semaphore area 356 has been changed. After confirming the change of the flag data, first processor 100 writes a response message indicating receipt of the access authority for first mailbox area 352. Then, first processor 100 exclusively has access authority for shared memory area 320 until an authority request of second processor 200 is given or the task of first processor 100 is completed.

In FIG. 5, a specific area of second bank 320 serving as the shared memory area can be identified as a disabled area while a row address assigned to internal register 350 within the specific area remains enabled. For example, a specific row address (0×7 FFFFFFFh˜0×8 FFFFFFFh, 2 KB size =1 row size) enabling a row of the shared memory area 320 can be assigned to internal register 350. Then, where the specific row address (0×7 FFFFFFFh˜0×8 FFFFFFFh) is applied, a corresponding specific word line area of the shared memory area can be disabled while register 350 remains enabled.

FIG. 6 is a block diagram illustrating an embodiment of second multi-port semiconductor memory device 302 shown in FIG. 4. Referring to FIG. 6, second multi-port semiconductor memory device 302 comprises a first bank 311, a second bank 321, a third bank comprising first and second half bank areas 331 and 332, and a fourth bank comprising first and second half bank areas 341 and 342. First bank 311, second bank 321, and first and second half bank areas 341 and 342 of the fourth bank are dedicated to second processor 200; first half bank area 331 of the third bank is dedicated to third processor 500; and second half bank area 332 of the third bank is shared by second processor 200 and third processor 500.

Second multi-port semiconductor memory device 302 comprises an internal register 350 and a path controller 370, similar to first multi-port semiconductor memory device 300.

FIG. 7 shows an example of internal storage areas in third non-volatile semiconductor memory device 420 shown in FIG. 4. In the example of FIG. 7, boot codes for third processor 500 are stored in a first area A1, the secondary boot loader for second processor 200 is stored in a second area A2, the OS image data for second processor 200 is stored in a third area A3, the secondary boot loader for first processor 100 is stored in a fourth area A4, the OS image data for first processor 100 is stored in a fifth area A5, and user data is stored in a sixth area A6.

The storage areas of FIG. 7 can be used to perform a booting operation of the system of FIG. 4 as described below.

Upon powering up of the system, first, second, and third processors 100, 200, and 500 read primary boot loaders from their internal ROMs and execute the primary boot loaders.

Third processor 500 then applies reset signals to first and second processors 100 and 200 through reset signal lines L2 and L4 to prevent first and second processors 100 and 200 from halting. Next, third processor 500 reads a primary boot loader for itself from first area Al of flash memory 420 and executes the primary boot loader to complete the booting of third processor 500.

Subsequently, third processor 500 releases second processor 200 from a reset state through reset signal line L2. Then, second processor 200 sets a serial interface, such as a UART port, while executing the primary boot loader.

Next, third processor 500 reads the secondary boot loader for second processor 200 from second area A2 of flash memory 420 and transmits the secondary boot loader to second processor 200 through serial interface line L1. Third processor 500 reads the OS image data for second processor 200 from third area A3 of flash memory 400 and stores the OS image data in second half bank area 332 of second multi-port semiconductor memory device 302.

Second processor 200 receives the secondary boot loader and controls the DRAM controller. Second processor 200 reads the OS image data from second half bank area 332 of second multi-port semiconductor memory device 302 and makes a copy of the OS image data in first bank 311 of second multi-port semiconductor memory device 302 to complete the booting of second processor 200.

After the booting of second processor 200, third processor 500 releases first processor 100 from a reset state through reset signal line L4. Then, first processor 100 sets a serial interface, such as a UART port, while executing the primary boot loader.

Next, third processor 500 reads the secondary boot loader for first processor 100 from second area A4 of flash memory 420 and transmits the secondary boot loader to first processor 100 through serial interface line L3. Third processor 500 reads the OS image data for first processor 100 from fifth area AS of flash memory 420 and stores the OS image data in second half bank area 332 of second multi-port semiconductor memory device 302.

Subsequently, second processor 200 reads the OS image data for first processor 100 from second half bank area 332 and stores the OS image data in second bank 320 of first multi-port semiconductor memory device 300. Next, first processor 100 receives the secondary boot loader and controls the DRAM controller. First processor 100 then reads the OS image data from second bank 320 and makes a copy of the OS image data in first bank 310 to complete booting of first processor 100.

As indicated by the above description, certain embodiments of the inventive concept provide flash-less multiprocessor systems having improved booting performance. Because these systems use one or more processors without an accompanying flash memory, they may be less expensive and more compact compared with other multiprocessor systems. Certain embodiments also provide multiprocessor systems comprising a memory link architecture that performs booting in the flash-less structure in conjunction with one or more multi-port semiconductor memory devices.

In certain embodiments, the multiprocessor systems comprise three or more processors, although the inventive concept is not limited to any particular number of processors, nor is the scope of the inventive concept limited to any special combination of processors or processor types. The processors in various embodiments can comprise, for instance, microprocessors, CPUs, digital signal processors, micro controllers, reduced-instruction set computers, complex instruction set computer, or any of several other types of processors.

It will be apparent to those skilled in the art that modifications and variations can be made in the above-described embodiments without departing from the scope of the inventive concept. Thus, it is intended that embodiments of the inventive concept cover any such modifications and variations of this inventive concept provided they come within the scope of the appended claims and their equivalents.

In various alternative embodiments, any of several features can be altered, such as the structure of the memory link architecture or the booting sequence for processors, the structure of shared memory bank of a multi-port semiconductor memory, the structure of the semaphore and mailbox areas in the internal register, and the structure of the circuit and the access method.

Furthermore, although some embodiments perform system booting using an ASIC processor, system booting can alternatively be performed using other types of processors, such as CPUs. In addition, the implementation of data path control to control data transmission between the ports and the shared memory area of the DRAM can take any of several alternative forms in addition to the above-described example using the semaphore and mailbox areas. Moreover, various alternative embodiments can use different types of nonvolatile memories, such as phase change random access memories and others.

The foregoing is illustrative of embodiments and is not to be construed as limiting thereof Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A multiprocessor system comprising:
a multi-port semiconductor memory device comprising a shared memory area and a plurality of mailbox areas used for inter-processor communication;
a first processor connected to the multi-port semiconductor memory device and comprising an internal read only memory (ROM) storing default initialization codes for initializing a dynamic random access memory (DRAM) controller in a booting operation of the first processor;
a second processor connected to the multi-port semiconductor memory device and performing communication with the first processor through the multi-port semiconductor memory device; and
a non-volatile semiconductor memory device connected to the second processor and storing user data, software, and boot loaders for the first and second processors.

2. The system of claim 1, wherein the ROM in the first processor stores a primary boot loader for the first processor, wherein the second processor comprises a ROM storing a primary boot loader for the second processor, and wherein the first processor initializes the DRAM controller with default parameters in accordance with the default initialization codes.

3. The system of claim 2, wherein the multi-port semiconductor memory device comprises a first memory area dedicated to the first processor and a second memory area dedicated to the second processor, and wherein the second processor performs a first transfer operation after executing the primary boot loader, the first transfer operation comprising reading second processor operating system image data from the non-volatile semiconductor memory device and storing the second processor operating system image data in the second memory area.

4. The system of claim 3, wherein the second processor further performs a second transfer operation after the first transfer operation, the second transfer operation comprising reading a secondary boot loader and first processor operating system image data from the non-volatile semiconductor memory device and storing the secondary boot loader and the first processor operating system image data in the shared memory area.

5. The system of claim 4, wherein the first processor performs a reset/copy operation after the second transfer operation, the reset/copy operation comprising reading the secondary boot loader from the shared memory area to reset the DRAM controller, reading the first processor operating system image data from the shared memory area, and copying of the first processor operating system image data in the first memory area.

6. The system of claim 5, wherein the second processor applies a reset signal to the first processor to prevent the first processor from halting during booting of the multiprocessor system.

7. The system of claim 1, wherein the nonvolatile memory device is a flash memory device.

8. A multiprocessor system comprising:
a first multi-port semiconductor memory device;
first and second processors connected to the first multi-port semiconductor device, the first and second processors having common access to the first multi-port semiconductor device; and
a memory link architecture block comprising:
a second multi-port semiconductor memory device connected to the second processor;
a non-volatile semiconductor memory device; and
a third processor connected to the second multi-port semiconductor memory device and the non-volatile semiconductor memory device, the third processor controlling booting of the first and second processors by transferring boot data from the non-volatile semiconductor memory device to the first and second processors.

9. The system of claim 8, wherein the second processor and the third processor are connected to each other through a serial interface line and a reset signal line.

10. The system of claim 9, wherein the third processor applies reset signals to the first and second processors to prevent the first and second processors from halting during booting of the multiprocessor system.

11. The system of claim 10, wherein the third processor controls booting of the second processor by releasing the second processor from a reset state, reading a boot loader and operating system image data for the second processor from the non-volatile semiconductor memory device, transmitting the boot loader through the serial interface line, and storing the operating system image data in a shared memory area of the second multi-port semiconductor memory device.

12. The system of claim 11, wherein the third processor controls booting of the first processor by releasing the first processor from a reset state following booting of the second processor, reading a boot loader and operating system image data for the first processor from the non-volatile semiconductor memory device, transmitting the boot loader through the serial interface line, and storing the operating system image data in a shared memory area of the second multi-port semiconductor memory device.

13. The system of claim 8, wherein the first and second processors receive data from the third processors via first and second respective universal asynchronous receiver/transmitter (UART) circuits.

14. The system of claim 8, wherein the third processor is an application specific integrated circuit (ASIC).

15. The system of claim 8, wherein one of the first and second processors is a multimedia processor.

16. A method of operating a multiprocessor system, comprising:
operating a first processor to execute a primary boot loader stored in a read only memory (ROM) coupled to the first processor;
operating a second processor to execute a primary boot loader stored in a ROM coupled to the second processor;
operating the second processor to read a second boot loader of the second processor from a nonvolatile memory, and to execute the second boot loader of the second processor to read operating system (OS) image data for the second processor from the nonvolatile memory;
operating the second processor to read a second boot loader of the first processor and OS image data for the first processor from the nonvolatile memory, and to store the second boot loader of the first processor and the OS image data for the first processor in a shared memory area in a multi-port semiconductor memory device; and
operating the first processor to read the secondary boot loader of the first processor and the OS image data for the first processor from the shared memory area, and to execute the second boot loader of the first processor.

17. The method of claim 16, further comprising:
initializing a dynamic random access memory (DRAM) controller of the first processor using default initialization parameters stored in the ROM coupled to the first processor, and subsequently resetting the DRAM controller with parameters defined by the second boot loader of the first processor.

18. The method of claim 16, wherein the multi-port semiconductor memory device comprises a OneDRAM device.

19. The method of claim 16, wherein the nonvolatile memory device comprises a flash memory device.

20. The method of claim 16, wherein the second boot loader of the first processor is transferred to the first processor by storing the second boot loader of the first processor in the shared memory and changing a state of a semaphore to provide the first processor with access to the second boot loader of the first processor.
